(19) United States
(12) Patent Application Publication
(10) Pub. No.: US 2002/0182372 A1
(43) Pub. Date: Dec. 5, 2002

(54) Lamination of planar items

(76) Inventor: Chee Peng Khor, Singapore (SG)

Correspondence Address: KILLWORTH GOTTMAN HAGAN & SCHAEFF, LLP, ONE DAYTON CENTRE, SUITE 500, ONE SOUTH MAIN STREET, DAYTON, OH, 45402-2023, US

(21) Appl. No.: 10/089,818

(22) PCT Filed: Aug. 8, 2001
(86) PCT No.: PCT/SG01/00160

(30) Foreign Application Priority Data
Aug. 8, 2000 (GB) 0019326.8

(51) Int. Cl. B32B 3/10

(52) U.S. Cl. 428/138

(57) ABSTRACT

A display device for mounting a substantially planar item such as a photograph (1) on a substrate (2) which may typically be of cardboard, a first layer of an ionomer (3) is provided over the photograph and an outer layer of a different, transparent, thermoplastics film (5) thereafter protects the photograph and ionomer layer. The advantage is that the ionomer does not permanently adhere to the photograph so that even though the display device may be hot laminated, the photograph may still be removed thereafter from the lamination without damage.

This invention relates to lamination and lamination techniques that are used to cover items such as photographs and documents.

A problem with known lamination techniques for covering e.g. items such as photographs is that in most instances the lamination cannot be removed without the item being destroyed. This makes the use of lamination techniques for mounting family photographs unsuitable such that for photographs that are to be openly displayed the choices available are effectively only a conventional picture frame with a glass or clear plastic window to protect the surface of the photograph, or a cardboard picture frame in the form of a sleeve into which a photograph may be inserted for display purposes, thereby risking damage to the surface of the photograph. Even photographs protected by glass can suffer degradation in certain circumstances, such as in hot and humid conditions that prevail in tropical and semitropical climates.

The present invention is derived from the realisation that there exists a need for protecting items such as photographs and documents to be displayed within an hermetically sealed environment such as between laminated transparent films whilst at some time being able to remove the item e.g. a certificate being displayed on a wall, without such being destroyed during the process.

According to a first aspect of the invention there is provided a display device for a substantially planar item, the device comprising of substrate onto which the item is mounted, and a laminated sheet hot laminated over the item and substrate, the laminated sheet comprising an inner layer of ionomer film and an outer layer of a different, transparent, thermoplastics film,

In this patent specification the term “item” is intended to include photographs, drawings, paintings, printed pictures, and any other substantially planar item capable of being displayed by the display device and thereafter retrieved from it.

Preferably, the display device includes a layer of ionomer film on both sides of the item which are laminated together at edge portions thereof surrounding the photograph or document, whereafter the resulting laminated structure may then be semi-permanently attached to a suitable substrate by having a layer of a different sheet material laminated thereover on one or both sides.

Conveniently, the substrate material is cardboard, which may conveniently be in the form of a picture frame having a suitably shaped aperture for displaying the photograph or document protected by the lamination layers,

The ionomer film and the film of a different, transparent, thermoplastics material may be laminated together using any conventional technique such as hot lamination, cold lamination and co-extrusion.

According to a second aspect of the invention there is provided a method of mounting items such as photographs or documents, the method including the steps of mounting the item on a substrate, covering the item with an inner film of ionomer and an outer film of a different, transparent, thermoplastics material, and thereafter hot laminating the inner and outer films onto the substrate and item.

The invention will now be described, by way of example only, with reference to the accompanying drawings, in which:

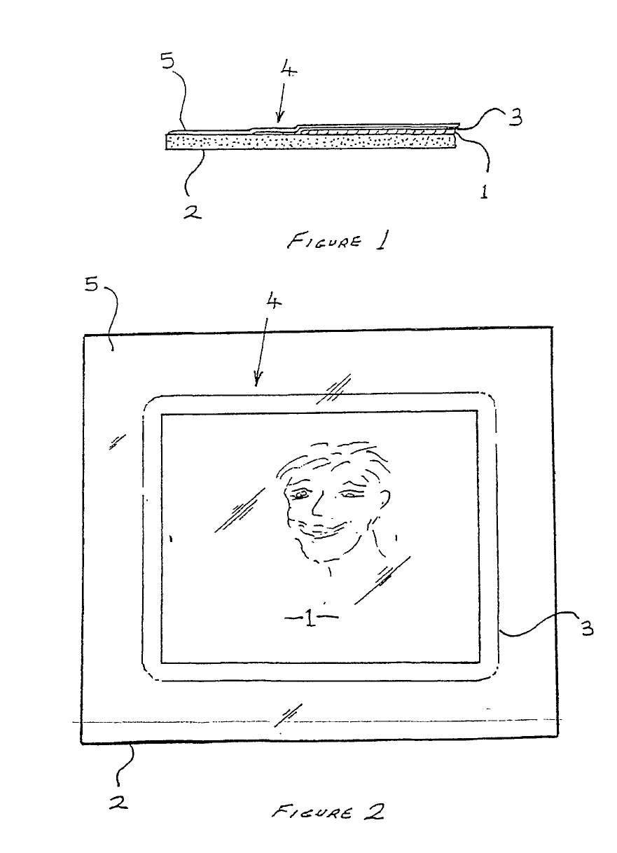

FIG. 1 shows a cross-sectional view of a photograph hot laminated to a backing board,

FIG. 2 is a front view of the photograph and backing board of FIG. 1.

Referring to the drawings, a photograph 1 is shown mounted on a substrate 2 which may typically be of cardboard. The photograph 1 is hot laminated onto the board by a two-step process. Initially, an inner film of an ionomer, such as that sold by reference to the trade mark Surlyn is placed over the photograph allowing edge portions of the ionomer 3 to slightly overlap the edges 4 of the photograph 1. Next, overlying the entire upper surface of the substrate 2 is placed an outer layer of another, different transparent film 5 which may be any thermoplastics other than an ionomer, such as polyester, PVC, polyethylene and so on. The resulting display device is then bonded together using conventional hot lamination techniques, such that the photograph 1 is essentially hermetically sealed from the environment by the lamination comprised of the ionomer layer 3 and the layer of other, different thermoplastics film 5.

Alternatively, the inner ionomer layer 3 and the outer thermoplastics film 5 may conveniently be laminated together in a separate operation using known hot lamination, cold lamination or co-extrusion techniques such that the resulting laminated structure can be provided on the roll and thereafter cut to the required size for placing over a substrate and an item to be mounted, following which the item may be hot laminated into the substrate with the inner ionomer film adjacent thereto and the outer film of a different thermoplastics material thereafter providing protection therefor.

In contrast to conventional lamination techniques used to protect items such as photographs and documents from the environment the present invention derives the benefit of the layer of ionomer adhering itself semi-permanently to the photograph or document and also to the covering layer of sheet material, such as polyester. Hence, all of the benefits of conventional lamination are retained, but when the photograph or document is required to be removed from the lamination structure, it has been found that by the use of a covering layer of ionomer it is possible to peel it away from the surface of the photograph or document without damage occurring.

The invention also envisages the use of the ionomer layer on both sides of the photograph or document such that identity cards, passports and the like can be safely protected by or with a device according to the invention. Similarly, the invention obviates the need to provide a glass or clear plastics cover for a photograph within a frame in order to protect the surface thereof. Instead it permits, e.g. a cardboard frame to be used within which may be mounted a photograph using the lamination techniques according to the invention which thereafter safely protect the photograph or document until such is required for some other purpose, such as mounting within a photo album or other storage facility.

The invention also envisages the use of conventional hot lamination equipment within or adjacent to conventional photographic processing establishments so that any chosen photograph can immediately be protected by and mounted within a display device according to the invention.

1. A display device for a substantially planar item, the device comprising a substrate onto which the item is mounted, and a laminated sheet, hot laminated over the item and substrate, the laminated sheet comprising an inner layer of ionomer film and an outer layer of a different, transparent, thermoplastics film.

2. A display device according to claim 1, which includes a layer of ionomer film on both sides of the item, which layers are laminated together at edge portions thereof.

3. A display device according to claim 2 in which the laminated structure is semi-permanently attached to a substrate sheet material.

4. A display device according to claim 3 in which the substrate material is cardboard.

5. A display device according to claim 4 in which the substrate material is in the form of a picture frame having a suitably shaped aperture for displaying an item protected by the lamination layers.

6. A method of mounting items such as photographs or documents, the method including the steps of mounting the item on a substrate, covering the item with an inner film of ionomer and an outer film of a different, transparent, thermoplastics material, and thereafter hot laminating the inner and outer films onto the substrate and item.

7. A display device substantially as herein before described with reference to the drawings.

8. A method of mounting items such as photographs or documents substantially as herein before described.
